(19) United States
(12) Patent Application Publication
(10) Pub. No.: US 2009/0055247 A1
(43) Pub. Date: Feb. 26, 2009

(54) System and method for classification of beverages

(76) Inventor: Jay Andrew Jackson, Atlanta, GA (US)

Correspondence Address: ROBERT Z. EVORA, 4741 PLANTERS WALK, DOUGLASVILLE, GA, 30135, US

(21) Appl. No.: 12/229,388

(22) Filed: Aug. 22, 2008

Related U.S. Application Data
(60) Provisional application No. 60/965,957, filed on Aug. 23, 2007.

(51) Int. Cl. G06Q 30/00; G06Q 50/00

(52) U.S. Cl. 705/10

(57) ABSTRACT

A system and method are provided to present a rating system for each perceived characteristic within a beverage. The system and method accurately records the input of multiple consumers to produce a prediction model representative of the perceived characteristics of a beverage. Using the prediction model, beverage characteristics may be compared and contrasted by the user.

### CROSS REFERENCE TO RELATED APPLICATION

This application is a Non-Provisional Application which claims the benefit of the filing date of U.S. Provisional Application Ser. No. 60/965,957, entitled “System And Method For Classification Of Beverages” filed Aug. 23, 2007, the entirety of which is incorporated herein by reference.

### BACKGROUND OF THE INVENTION

1. Field of the Invention

The instant invention relates to a system and method for classifying beverages having consumer input via a graphical interface.

2. Description of the Related Art

With the advent and production of multiple water sources, multiple ingredients and multiple flavored consumer beverages, a consumer has an increasingly larger quantity of beverage choices today. Beverage genres, such as, flavored waters, flavored sodas and microbrewed beer, allow consumers to choose amongst thousands of varieties of beverages within a particular beverage genre. For example, bottled waters now come flavored with fruit, a variety of sweeteners, energy additives, are also captured from multiple water sources, such as springs, distilleries, and have different filtering processes. Unfortunately, due to the many methods employed in each genre, different taste characteristics result from these new processes. Accordingly, it has become increasingly difficult to predict the taste characteristics of beverages within each genre. Likewise, it is increasingly more difficult for a consumer to keep up with their favorite tastes preferences in view of the plethora of new products already on the market and those emerging daily.

For example, microbreweries have become increasingly popular within the last decade. Each microbrewery has a beer master who is responsible for the recipes and making the beer for each microbrewery. This poses a significant problem in that each beer master has their unique way of producing beer in their own microbrewery. Another contributing factor, especially in beer making, is the equipment set up of each distillery. Different equipment setups may cause beer to taste different and have uneven flavor characteristics, even when made from the same recipe or made to be a part of a particular subgroup within the genre, such as lagers or pilsners in the beer genre. With that, a consumer may purchase, for example, an amber pilsner at a microbrewery expecting a particular flavor characteristic but in actuality, it may taste more like a lager from another brewery or vice versa. This poses an issue to consumers when they are attempting to find a duplicate for the taste of their favorite beer between microbreweries that they frequent or with other more widely distributed beers. Likewise, the added complication of the seasonal beer adds to the confusing mix.

Beer is traditionally labeled with a broad classification system that does not take into account other available characteristics that may be perceivable in taste to a consumer. For the most part, categories of color, yeast and style are used for classification in the everyday consumption and sale of beer. Some examples of each of these characteristics are amber, pale and dark when characterizing color; top fermenting, bottom fermenting and spontaneous, when characterizing yeast; and English Bitter, Pilsner Lager, Brown Ale and Porter, when characterizing style.

This broad classification system does not account for the fact that all amber pilsners, for example, do not have the same taste characteristics. Therefore, for various reasons, it is sensible to have at one's disposal a reliable method for classifying beverages, such as beer, that is readily available to consumers and in which consumers may provide input into the classifications and receive suggestions based on each of their unique beer interests.

Monitoring beverage products in terms of their taste characteristics by way of their perceived taste is hereby possible. It is possible to illustrate, through consumer ratings criteria, whether a beverage will be similar to a beer that is available at all microbreweries. Also, wide spread monitoring of the production process and maturation in storage in the course of beverage production by the beer master would be achievable with such a classification system.

There are other various means used to predict these characteristics including the use of highly trained beer tasters that are employed to decipher and interpret the characteristics of the beer. However, this approach is limited to a relatively small number of people and is not readily available to most consumers and is not updated in an ongoing and dynamic manner.

There is a need for a method for providing the characteristics of a beverage that is readily available to all consumers, will allow input from many different consumers, allow dynamic updating, and provide suggestions in response to the inquiry. This invention provides an adequate means for having a dynamic and infinite sampling of beverage characteristics, as perceived by a consumer, that is easy to use and without the need for special training. There is a need for such a device that also provides sufficient space to record any necessary data associated with each consumer beverage rating and to provide accessible profiles for each consumer.

### SUMMARY OF THE INVENTION

The following presents a summary in order to provide a basic understanding of some aspects of the disclosed innovation. This summary is not an extensive overview, and it is not intended to identify key/critical elements or to delineate the scope thereof. Its purpose is to present some concepts in a simplified form as a prelude to the more detailed description that is presented later.

The present invention provides a classification system and method that can accurately record the input of multiple consumers to produce a prediction model representative of the perceived characteristics of a beverage, such as beer, to a consumer. The device also has space to record the numerical data of each characteristic and present a mathematically calculated rating of each characteristic that is representative of an overall rating of the characteristics within a beverage.

It is an object of the present invention to provide a recording medium that can be used to provide a display of an accurate representation of various types of information being measured related to the beverage classification system and method.

Another object of the present invention is to provide a system and method including a simple interface that a consumer can use without the assistance of any special training in the art of beverage tasting. Likewise, another aspect of this invention is to dynamically provide comparable ratings criteria amongst beverages within a genre and their subgroups.

A further object of the present invention is to provide a measuring device and/or medium that has sufficient space and/or means to record various measurements and other significant data related to a user's input and/or information retrieved from various sources, such as other sites on the Internet, or residing anywhere in form, electronic or not, which may be accessed and/or input in accordance with this invention.

Another object of the present invention is to provide a graphical user interface that contains multiple characteristics used to classify each characteristic of the beverage, wherein the multiple characteristics used are taken from a larger group of characteristics used in the professional art of beverage tasting.

It is also an object of the present invention to provide a graphical user interface (hereafter, may be referred to as a “GUI”) that is securely maintained to facilitate the recording of the characteristics and other data to be displayed to a consumer accessing the graphical user interface.

The graphical user interface may be used to record multiple characteristics of a beverage. The entry of that information may be performed using an interactive graphical user interface having multiple sliding means used to establish a range of data which corresponds to a record of a consumer's rating of each characteristic, each of the sliding means having measurement markings thereon.

The results generated by one or more of the graphical user interfaces may be used to identify, access, manipulate and view beverage classification information, such as events and services. The information generated and returned by the graphical interfaces may be tailored according to a user's desired preferences.

According to systems and method of this invention, various types of information may be automatically generated, in response to the user's specific requests and/or settings. The information returned may include access to, and stored hyperlink and/or hypermedia information related to beverage classification information. The information may be tied into and displayed via related links, Web pages or content. The beverage classification information retrieved may be displayed from the graphical user interface or Web in various user-friendly formats as a comprehensive, organized whole.

According to the systems and methods of this invention, the information collected and displayed may continuously update a user profile based on the user's Web and non-Web related activities.

It is a further object of the invention is to identify, access, retrieve and store beverage classification information and events taking place in the local community or on the Web based on a user's profile and input, either automatically or in response to a user's specific command.

Updated information about the beverage classification system and/or other Web based information, based on a user's profile, may be continuously updated to alert the user when such updates occur and to provide summary information regarding the updates. The systems and methods of this invention also provide for user's to continue an Internet and/or off-line session from where the user left last off.

Another object of the systems and methods of this invention is to provide monitoring and scanning of the Internet for net-casted beverage classification programming and/or other information and events related to beverages and beverage manufacturers contained in a local database. Likewise, the information and events may be adapted for use with a user-friendly, time oriented graphical user interface.

Information may be collected from a variety of different locations, including but not limited to, the downloading of past, present or future Web and non-Web related information, content and events related to beverage classification by means of a user-friendly GUI, either automatically or in response to a user's specific command.

Another object of the invention is to provide for the access, retrieval and storage of summary or detailed information on the Web for selected objects by merely “highlighting” the objects and providing hyperlinks to such information and event occurrences.

The systems and methods of this invention are adapted to create user-specific profiles for multiple users based on their Web and non-Web related activities. The profiles are continuously updated and evaluated. The system may use a user's profile to notify the user of forthcoming Web and non-Web events, broadcasts or other information deemed by the system to be pertinent to the user's interests, such as beverage classification information. Using this profile, for example, the system can update the GUI with net programming of which the user is unaware but which is likely to be of interest to the user. Preferably, the system downloads such programming for subsequent off-line viewing.

Another feature of this invention is the use of a user's profile to identify and notify a user when Web sites of interest have been modified in a way related to the interests specified by the profile. In one preferred embodiment, the systems and methods of this invention provide summary information of the modification so that the user can readily evaluate whether the change is of importance.

The systems and methods of this invention identifies and downloads related hypertext and hypermedia links found in the Web page being viewed by the user, including Web pages linked to the first and higher tier pages. Preferably, this downloading takes place in the “background” and is transparent to the user. Alternatively, the system might automatically download all links within a domain only. Or, the user can specify the number of related links which the system will identify and download. Further, the system automatically terminates an Internet connection after downloaded is complete. In addition, according to yet another embodiment, the downloaded information is displayed as a comprehensive whole in a manner prescribed by the user, such as pages in a book, file card format or any other manner.

Yet, another feature of the systems and methods of this invention is to allow the user to continue an Internet or off-line session at the Web page, document or content the user last viewed prior to terminating the previous session. This may be accomplished regardless of whether the Web page, document or content is stored on the system or whether the system must connect to the Internet to display the information.

To the accomplishment of the foregoing and related ends, certain illustrative aspects are described herein in connection with the following description and the annexed drawings. These aspects are indicative, however, of but a few of the various ways in which the principles disclosed herein can be employed and is not intended to include all such aspects and their equivalents. Other advantages and novel features will become apparent from the following detailed description when considered in conjunction with the drawings.

These and other objects, features, and/or advantages may accrue from various aspects of embodiments of the present invention, as described in more detail below.

### BRIEF DESCRIPTION OF THE DRAWINGS

Various exemplary embodiments of this invention will be described in detail, wherein like reference numerals refer to identical or similar components or steps, with reference to the following figures, wherein:

FIG. 1 illustrates an exemplary graphical user interface used to measure and record a series of beverage characteristics in accordance with a first embodiment of this invention.

FIG. 2A illustrates an exemplary graphical user interface wireframe containing user selectable beverage characteristics to be used in the exemplary graphical user interface of FIG. 1 in accordance with this invention.

FIGS. 2B and 2C illustrate an alternate method for selecting flavors to be used to characterize beverages in accordance with this invention.

FIG. 3 depicts an illustration of a resulting mathematical characteristic rating stored for subsequent viewing and comparison by consumers in accordance with the first embodiment of this invention.

FIG. 4 illustrates an exemplary graphical user interface used to measure and record a series of beverage characteristics in accordance with a second embodiment of this invention.

FIG. 5 represents a block diagram depicting one exemplary embodiment of a beverage classification system according to the embodiments of this invention.

FIG. 6 represents a block diagram depicting one exemplary embodiment of a beverage classification program according to the embodiments of this invention.

FIG. 7 represents and exemplary method for the beverage classification system according to the embodiments of this invention.

### DETAILED DESCRIPTION OF EXEMPLARY EMBODIMENTS

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and graphical user interfaces are shown in block diagram form in order to facilitate describing the claimed subject matter.

As used in this application, the terms “component,” “module,” “system”, “interface”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution (and/or control programs) and a component may be localized on one computer and/or distributed between two or more computers. As another example, an interface can include I/O components as well as associated processor, application, and/or API components, and can be as simple as a command line or a more complex Integrated Development Environment (IDE).

Furthermore, the claimed subject matter may be implemented as a system, method, apparatus, carrier wave, or article of manufacture using, and/or involved with, standard programming and/or engineering techniques to produce software, firmware, hardware, or any combination thereof to control a computer to implement the disclosed subject matter.

The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic instructions or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms to “infer” or “inference” refer generally to the process of reasoning about or inferring states of the system, environment, and/or consumer from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Particular embodiments of the present invention will now be described in greater detail with reference to the figures. While the exemplary embodiments of this detailed description depict a method for characterizing beer, it should be appreciated that any beverage can be classified using the system described herein.

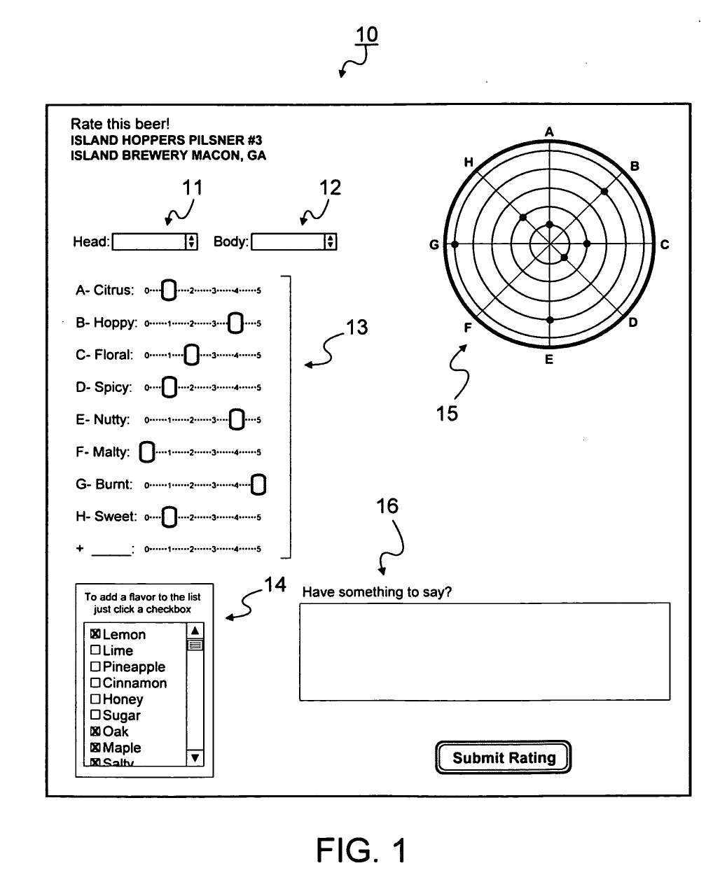

FIG. 1 illustrates an exemplary graphical user interface 10 used to measure and record beverage characteristics according to a first embodiment of the systems and methods of the beverage classification system 100. The graphical user interface 10 includes various measurement indicators to characterize beverages in accordance with this invention.

Although shown herein for exemplary purposes, it is to be understood that the various characteristics may be displayed and controlled in a variety of different ways. The various characteristics may be predefined and selectable by a user interacting with the systems and methods of this invention. Alternatively, the various characteristics may be added to, subtracted from, and/or otherwise manipulated by a user in a variety of different ways in order for a given use to set up their own unique preferences. If a user desires to add a preferred characteristic, the additional characteristic may be dynamically included (as will be described later) via an entry point in the graphical user interface 10. The graphical user interface 10 may be updated and the new settings may be reflected on a renewed graphical user interface 10 rendition.

More specifically, the graphical user interface 10 illustrates a series of selectable characteristics that may be used to rate and classify a particular beverage, such as beer. For example, as shown, the graphical user interface 10 may contain descriptive physical characteristics of a beverage, such as the type of head and/or body that are selectable using drop down menus 11 and 12 respectively.

The head and body drop down menus 11 and 12 may contain predefined (or dynamically inclusive) descriptive terms of the physical attributes of the beverage, such as flat or foamy when characterizing the head of a beer. Likewise, descriptive terms, such as, full, medium and robust may be used when characterizing the body of a beer.

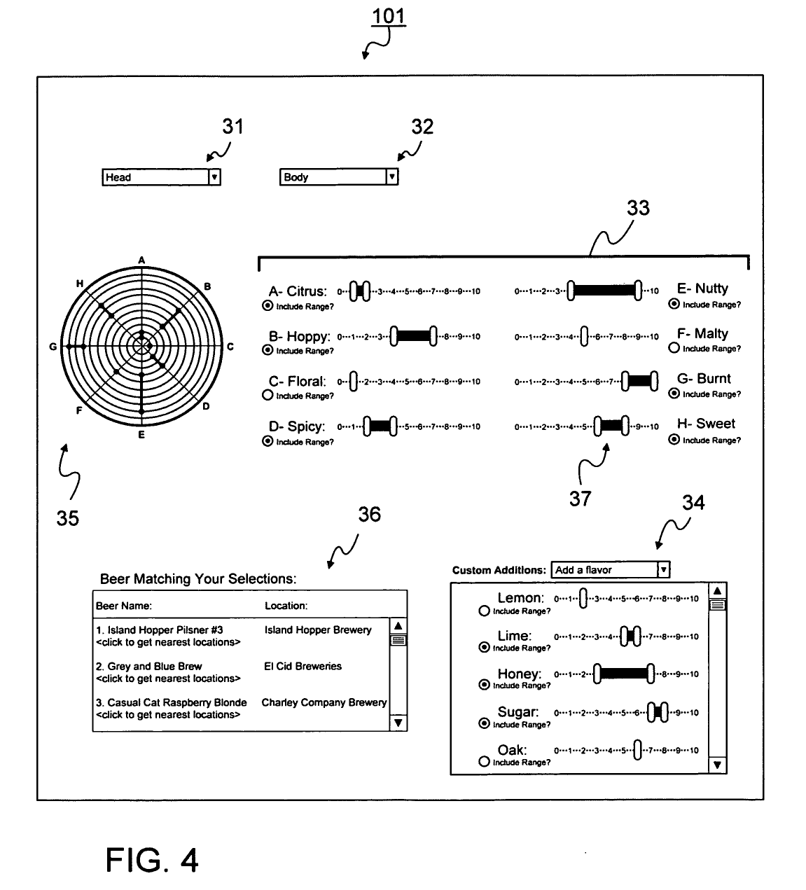

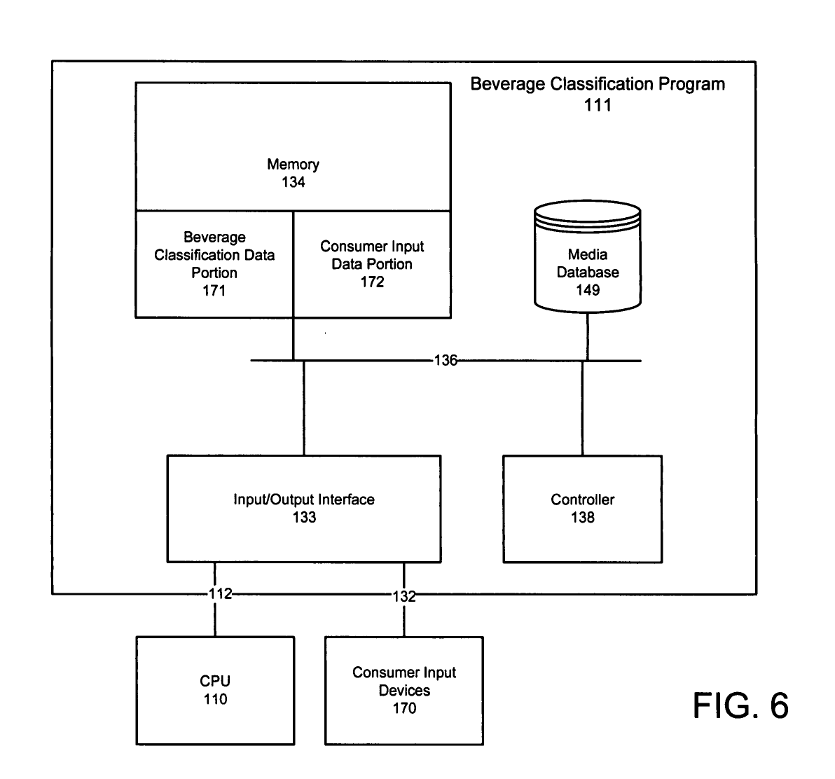

The graphical user interface 10 may contain a series of slidable input devices 13. The slidable input devices 13 are representative of quantitative characteristics of a particular beverage. For example, as indicative of the traditional characteristics of a beer, the slidable input devices 13 can be selectively movable to provide a quantitative rating of each of the individual characteristic, such as: Citrus (corresponds to reference A), Hoppy (corresponds to reference B), Floral (corresponds to reference C), Spicy (corresponds to reference D), Nutty (corresponds to reference E), Malty (corresponds to reference F), Burnt (corresponds to reference G), and Sweet (corresponds to reference H). Numerous other beer tasting characteristics may be shown, such as, but mot limited to Fruity, Astringency, Bitterness, Sourness, Caramelized, Alcohol, Estery or Worty for the various perceived levels in a beer. These quantitative characteristics represent a set of commonly used characteristics that can be used as a baseline for the comparison of beverages, such as beer. These basic or traditional characteristics may be statically programmed into the system for use during processing. For example a comparison of like terms can be calculated and used by the system to provide suggested beverages to a consumer in accordance with the systems and methods described and shown with respect to FIGS. 4 and 6 below. As mentioned briefly above, consumers may input additional beverage characteristics to their liking in a flavor picker 14 as shown in the graphical user interface 10. For example, based on the consumers experience, the consumer may perceive specific fruits and/or tastes in a particular beverage, such Lemon, Lime, Pineapple, Cinnamon, Honey, Sugar, Oak, Maple, Salty, Blueberry, Cherry, and/or any other unlimited number of other flavors that may not be represented in the commonly used characteristics shown in the slidable input devices 13. As shown herein, the user may select from a predefined list of various defined characteristics, however, it is also possible for a new characteristic, not among one of the listed in the flavor picker 14 to be inserted and considered as part of the particular profile for a beverage.

The flavor wheel 15 depicts a graphical representation of the values selected in each traditional characteristic displayed in the slidable input devices 13. Each marking on the flavor wheel 15 represents the quantitative value of the characteristic selected by the slidable input devices 13 perceived by the consumer. For example, as shown in FIG. 1, a consumer has decided to rate Island Hoppers Pilsner #3. Here, the characteristics: Citrus (corresponds to reference A), Hoppy (corresponds to reference B), Floral (corresponds to reference C), Spicy (corresponds to reference D), Nutty (corresponds to reference E), Malty (corresponds to reference F), Burnt (corresponds to reference G), and Sweet (corresponds to reference H), are illustrated as the traditional characteristics used in the slidable input devices 13. It should also be appreciated that the flavor wheel 15 also allows the consumer to drag and adjust thereon the representative marks (shown in FIG. 1 as dots) to manipulate the quantitative values shown in the slidable input devices 13 and vice versa. As mentioned above, the flavor wheel 15 may also be dynamically adaptable to allow the consumer to add selections by entering their selectable characteristics that are not currently available on the flavor wheel 15.

Input box 16 allows consumers to input various types of information, such as comments associated with the particular beverage. These exemplary comments may include information for example, of the consumer's own perceptions of the beverage that may not be described by the selectable characteristics defined by any of the use of the drop down menus 11 and 12, the slidable input devices 13 or the flavor picker 14. For example, a consumer may input comments that give that beverage's comparative taste to other beverages on the sales market and/or make suggestions on where to find similarly tasting products.

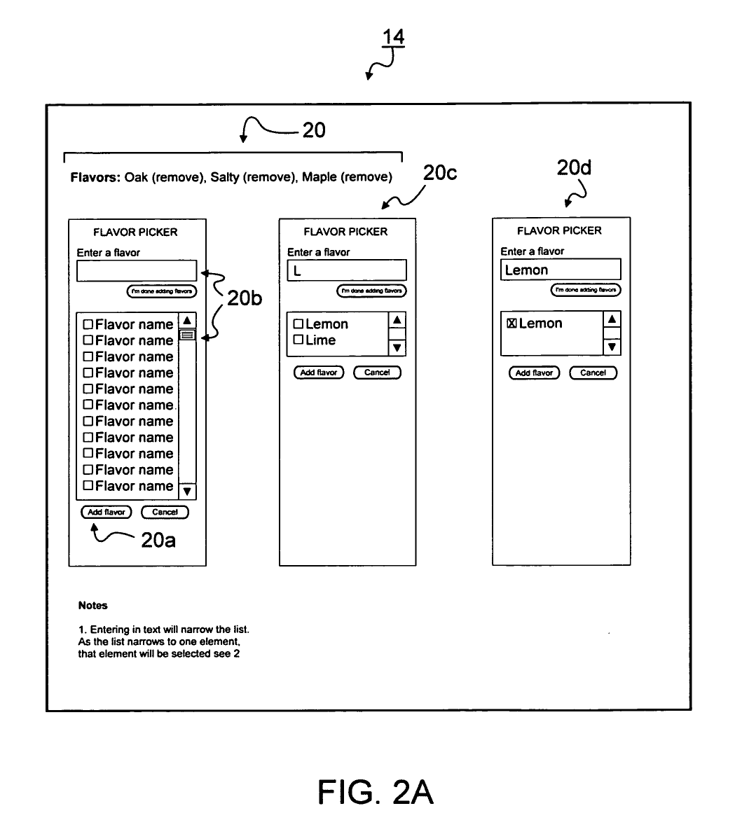

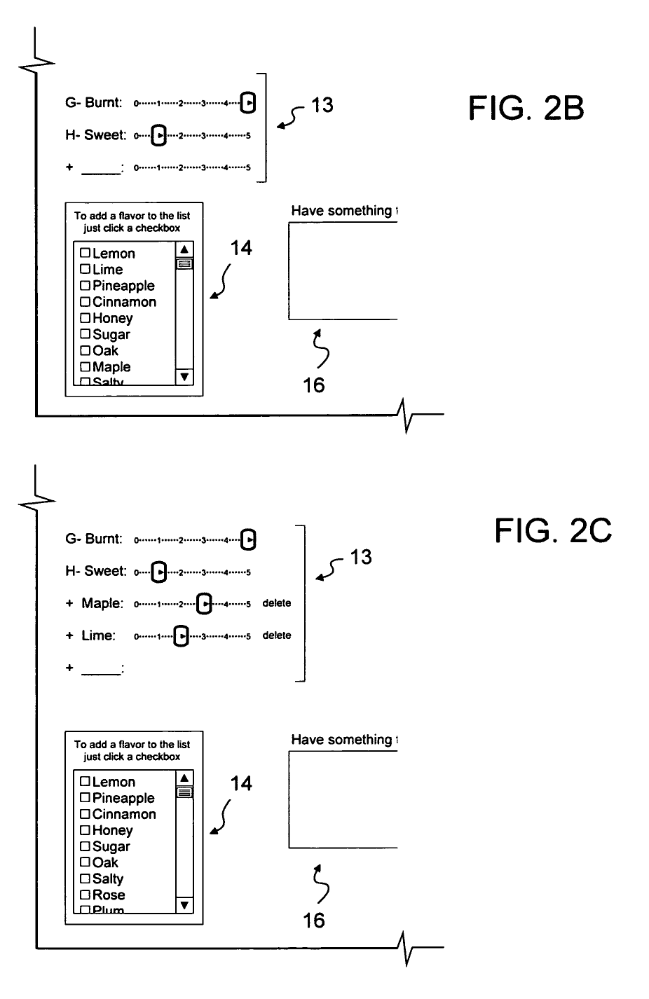

Additionally, as shown by the boxes selected in the flavor picker 14 in FIG. 1, the consumer has selected to add the flavors, Oak, Maple and Salty taste characteristics in the beverage in the flavor picker 14. It should be appreciated that the flavor picker 14 may contain an infinite number of flavors and/or attributes that would not be represented in the slidable input means 13. More detail as to the use of the flavor picker 14 is described in more detail in FIGS. 2A through 2C.

Although the exemplary user interface shown in FIG. 1 depicts drop down menus, slidable interfaces and input boxes, it should be appreciated that any type of input device, now known or later discovered, in accordance with this invention is contemplated.

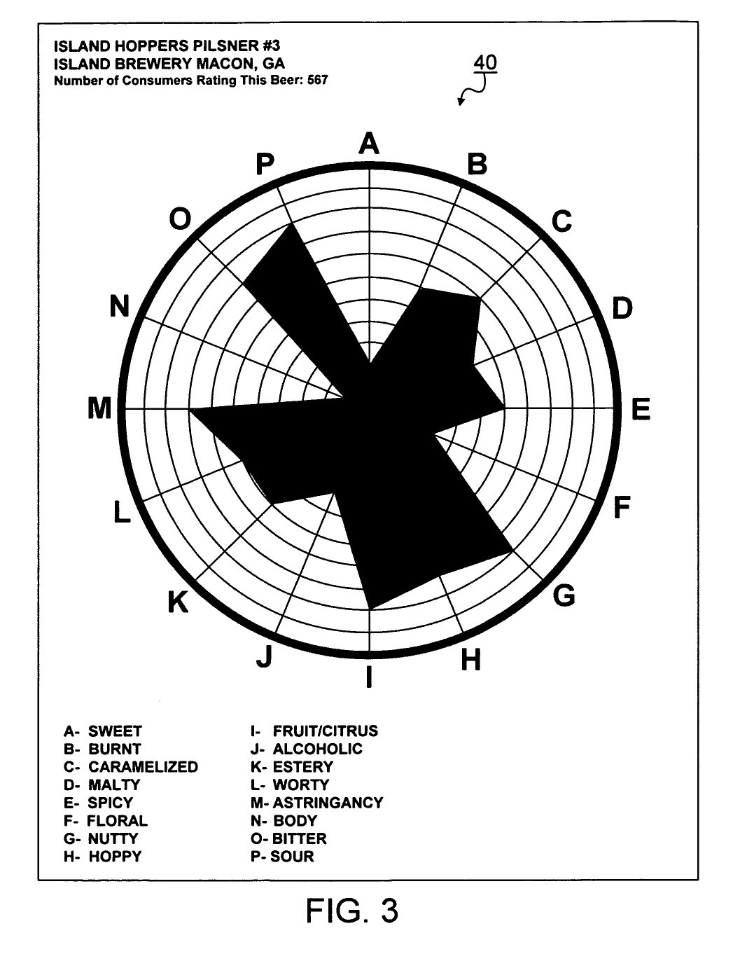

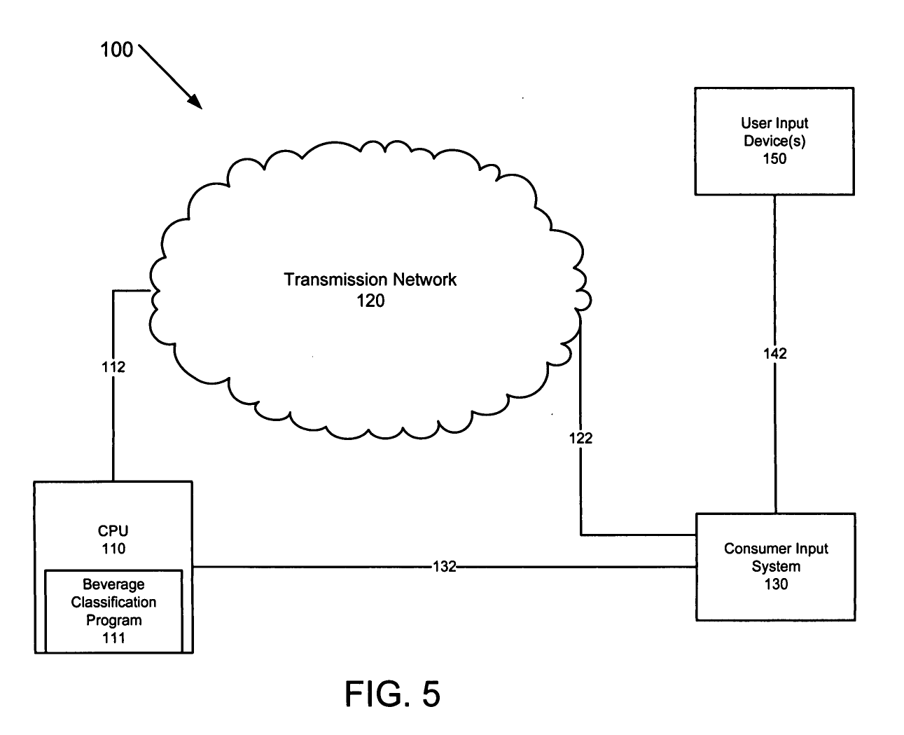

FIG. 2A illustrates an exemplary embodiment of the flavor picker 14, wherein the consumer has the option to add a flavor 20a and/or select a flavor 20b that is not represented in the traditional characteristics as shown in input devices 13 in FIG. 1. Here, the consumer can create flavors based on the predefined flavors, their own preferences and/or select flavors that have been used to characterize that beverage by other consumers previously accessing the system. For example, as shown by selected flavors 20, this consumer has chosen to add: Oak, Maple and Salty as distinguishing characteristics. It should be appreciated that a consumer may save their ratings selections for use with respect to use in calculating a histogram as described in FIG. 3 and later used in FIG. 5 to provide suggestions to consumers.

As shown in FIG. 2A, the flavor picker 14 user interface may use predictive text programming 20c to help the user narrow down their preferred selection and ultimately choose a preferred flavor. As shown in 20c, the user may enter the letter “L” and the system will match the letter against a list of characteristics starting with the letter “L.” As shown, “Lemon” and “Lime” appear as potential choices from which the user may select.

In box 20d, the user selects “Lemon” as the preferred characteristic to be added to describe the characteristic taste in which this particular beverage tastes. According “Lemon” is the ultimate preferred selection. “Lemon” may be added to the list of selected flavors 20 once the “Add flavor” button is selected in FIG. 20d.

The various selected flavors 20 may also be easily removed from the list of selected flavors 20 by selecting the “(remove)” label adjacent to the selected flavors 20 recently added and listed in selected flavors 20.

FIGS. 2B and 2C illustrate an alternate method for selecting flavors to be used to characterize beverages in accordance with this invention. As shown in more detail, in FIG. 2B, using a simple checkbox method, a consumer is able to add flavors to be included as a characteristic of a particular beverage being rated. For example, in FIG. 2B, the consumer has chosen to add “Maple” and “Lime” as flavors descriptive of the particular beverage.

In operation, and as shown in FIG. 2b, the consumer may simply place a checkmark in a box beside the desired flavor and use a user input method, such as a mouse click to add the flavor. The populated flavors shown (as well as various others not shown) in the flavor picker 14 can be preprogrammed by a webmaster or a method may be provided where the consumer may add custom flavors to be included under their individual user profile.

As shown in FIG. 2C, the flavors selected, i.e., “Maple” and “Lime” have been added as potential choices defined by slidable input devices 13 from which the user may select. Likewise, a designation to “delete” the particular taste characteristic selection may be added for convenience.

FIG. 3. depicts an exemplary histogram 40 of the average rating of the traditional characteristics chosen by consumers for the exemplary beer, Island Hoppers Pilsner #3. This histogram 40 illustrates a graphic rendition of a mathematical representation of the various inputs received from each consumer and saved in the beer classification system.

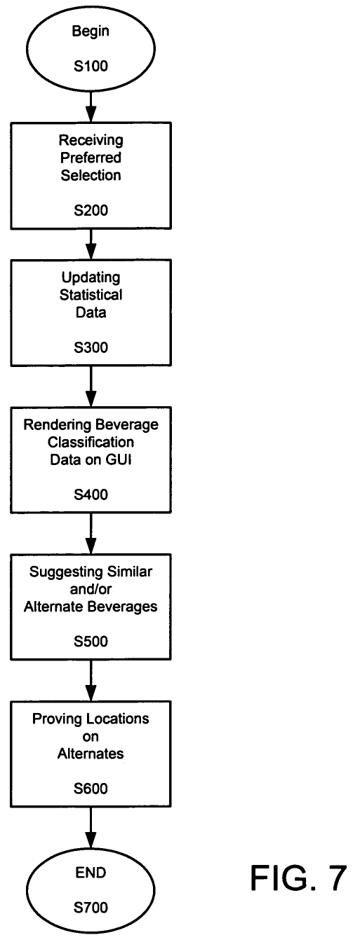

The mathematical representation may be shown as an average of each value selected by a consumer and/or any now known or later developed mathematical method for calculating a quantitative value for presentation on a graph or histogram. With the use of the histogram 40 shown in FIG. 3, a consumer is able to view an average rating of the beverage and compare this to other beverages stored in this system, as will be described later in FIG. 7. For illustrative purposes, the alphabetical letters correspond to the taste characteristics listed below the histogram 40.

FIG. 4 illustrates another exemplary embodiment of a graphical user interface 101 used to record and search beverage characteristics in accordance with a second embodiment of this invention. The graphical user interface 101 shown in wire frame includes various measurement indicators to characterize beverages in accordance with this invention. More specifically, the graphical user interface 101 provides a series of selectable characteristics used to rate and classify a particular beverage, such as beer. Using this exemplary embodiment, a user may identify various beverages having preferred characteristics which may be selected by a consumer.

For example, the graphical user interface 30 may contain descriptive physical characteristics of a beverage, such as head or body that are selectable using a drop down menus 31 and 32. The drop down menus 31 and 32 may contain descriptive terms of the physical attributes of the beverage, such as flat or foamy when characterizing the head of a beer and descriptive terms, such as, full, medium and robust when characterizing the body of a beer. Additionally, the graphical user interface 101 may integrate a series of slidable range devices 33, representative of a range of quantitative characteristics for a particular beverage.

For example, as indicative of the traditional characteristics of a beer, the slidable range devices 33 can be movable to provide a range of quantitative ratings of each characteristic: Citrus (corresponds to reference A), Hoppy (corresponds to reference B), Floral (corresponds to reference C), Spicy (corresponds to reference D), Nutty (corresponds to reference E), Malty (corresponds to reference F), Burnt (corresponds to reference G), and Sweet (corresponds to reference H). Any type of characteristic description may be selected in accordance with systems and methods of this invention. Other characteristics may include but not limited to, for example: Fruity/Citrus, Astringency, Bitterness, Sourness, Caramelized, Alcohol, Estery or Worty level of a beer.

At least one toggle button 37 is provided and associated with each of the selected characteristics. The various slidable range devices 33 shown in FIG. 4 may be modified into any given suitable range for search criteria. For example, and as shown in FIG. 4, the characteristic “A—Citrus” may include a quantitative measurement defined by the range from approximately 1 to 2. Likewise, various other characteristics include ranges.

In the alternative, FIG. 4 also illustrates for example, the consumer having the capabilities to select not to include range criteria for the “F—Malty” characteristic. These ranges of quantitative ratings represent a set of commonly used characteristics that can be used as a baseline for the searching and comparison of beverages, such as beer.

These basic or traditional characteristics may be statically programmed into the system and selected in a variety of different ways. A comparison of like terms can be used when the system provides suggested beverages to a consumer in accordance with the methods described with respect to this method and FIG. 7.

Also, in accordance with this invention, consumers may choose to input additional beverage characteristics according to their personal preference into the flavor picker 34. For example, a consumer may perceive specific fruits and/or tastes in the beverage, such Blueberry, Cherry, Lemon or other flavors that would not be represented in the commonly used characteristics shown in the slidable range devices 33.

The flavor wheel 35 is an overall graphical representation of the values selected in each traditional characteristic displayed in the slidable range devices 33. Each mark(s) on the flavor wheel represents the quantitative value of the characteristic selected by the slidable range devices 33 by the consumer. For example, as shown in FIG. 4, a consumer has decided to search for at least one beverage including the characteristics shown by the designation of the slidable range devices 33. As the user changes or modifies the ranges, the previously stored matching beverages are dynamically updated. Here, the characteristics Citrus, Hoppy, Floral, Spicy, Nutty, Malty, Burnt and Sweet are illustrated as the traditional characteristics used in the slidable range devices 33. It should also be appreciated that the flavor wheel 35 is an interactive tool in which the consumer may be allowed to drag and adjust the marks associated with each of the various characteristics (shown in FIG. 4 as line segments) to manipulate the quantitative values shown in the slidable range devices 33 and vice versa. In accordance with systems and methods of this invention, the flavor wheel 35 may be dynamically adapted to allow consumers to add selections by entering their selectable characteristics that may not currently available on the flavor wheel 35.

Selection box 36 dynamically displays previously stored beverages matching the ranges input into the slidable range devices 33. For example, as shown in the selection box 36 of FIG. 4, beer selections 1-3 have been displayed as selections matching the ranges input into the slidable range devices 33 and the flavor picker 34. The selection box 36 is identifies various beverages having preferred characteristics which correspond to the various characteristics selected by a consumer, as shown defined by the slidable ranges 33 shown in FIG. 4.

Hyperlinks may also be provided, as shown in selection box 36, which may be adapted to convey the location that currently serves the beverages 1-3. in accordance with systems and methods of this invention, directions to a nearby location serving the beverage, or access to web-links and the like, may also be provided for further use by the consumer.

Additionally, as shown in FIG. 4, the consumer has selected to add the flavors Lime, Honey, and Sugar in the beverage in flavor picker 34 and has provided those flavors. For each of the selections, various ranges have also been selected by the slidable input devices, as additional search criteria for the system according to this embodiment of this invention. It should be appreciated that the flavor picker 34 may contain an infinite number of flavors and/or attributes that would not be represented in the slidable input means 33. More detail as to the use of the flavor picker 34 is described in more detail with respect to FIG. 2 above.

Although the exemplary user interface 101 shown in FIG. 4 uses drop down menus 31, 32, slidable interfaces 37 and input boxes 34, it should be appreciated that any type of input device, now known or later discovered, in accordance with this invention is contemplated.

FIG. 5 shows one exemplary embodiment of a beverage classification system 100. As shown, the beverage classification system 100 includes a consumer input system 130. One or more user input devices 150 are connected to the consumer input system 130 via one or more communication links 142.

The one or more user input devices 150 can be any known or later-developed device usable to input data and/or commands, such as a keyboard, a mouse, a voice recognition system, a digital ink pen, a trackball, a track pad or the like. The consumer input system 130 is connected to a CPU 110 of the beverage classification system 100 either directly over a link 132 or over links 122 and 112 and a transmission network 120 of the beverage classification system 100.

The bidirectional links 112, 122, 132 and 142 and the transmission network 120 can be any now known or later-developed device or system usable to connect the one or more user input devices 150 and the CPU 110 to the consumer input system 130, including, but not limited to, a direct cable connection, a connection over a wide area network or a local network, a connection over an intranet or a connection over an extranet, a connection over the Internet, a wireless connection, or a connection over any other distributed processing network or system. In general, the links 112, 122, 132 and 142 and the transmission network 120 can be any appropriate known or later-developed connection system and/or structure for transferring information, such as computer readable program code, a carrier wave and/or any other type of executable program or instruction.

The CPU 110 contains a beverage classification program 111. Classification data, such as text, can be retrieved by the consumer input system 130 from the beverage classification program 111 through CPU 110 and collaboratively shared by the components of the consumer input system 130. It should be appreciated that CPU 110 can be a local or remotely located computer, or any other known or later-developed system usable to generate electronic data or beverage classification information. Similarly, the CPU 110 can be any suitable device that stores and/or transmits electronic beverage classification data, such as a client or a server of a network. The CPU 110 can be integrated with the consumer input system 130 or may be remotely connected to the consumer input system 130, such as over the transmission network 120. It should also be appreciated that the beverage classification program 111 is preferably dynamically implemented on a general-purpose computer, for example CPU 110. However, the beverage classification program 111 can also be implemented on a special purpose computer, a programmed microprocessor or microcontroller and peripheral integrated circuit elements, an ASIC or other integrated circuit, digital signal processor, hardwired electronic or logic circuit such as discrete element circuit, programmable logic device such as PLD, PLA, FPGA or PAL, or the like. In general, any device capable of supplying appropriate beverage classification data that can be used in the flowchart shown in FIG. 7.

FIG. 6 shows an exemplary embodiment of various components of the beverage classification program 111 according to this invention. As shown, the beverage classification program 111 includes an input/output interface 133, controller 138, memory 134, and media database 149, each interconnected by one or more bidirectional data/control buses or application programming interfaces 136.

Furthermore, one or more consumer input devices 170 are connected over one or more links 132 to the input/output interface 133. The consumer input device 170 includes the user input device 150 and the consumer input system 130 from FIG. 5. Additionally, CPU 110 is connected over communication link 112 to the input/output interface 133.

It should be understood that each of the circuits or routines shown in FIGS. 5 and 6 could be implemented as portions of suitably programmed general-purpose computer. Alternatively, each of the circuits or routines in FIGS. 4 and 5 could be implemented as physically distinct hardware circuits within an ASIC, or using FPGA, PDL, PLA or PAL, digital signal processor, or using discrete logic elements or discrete circuit elements. The particular form of each of the circuits or routines shown in FIGS. 5-6 and 7 will take is design choice and will be obvious and predicable to those skilled in the art.

Each of the links 112 and 132 can be implemented using any known or later developed device or system for connecting the one or more consumer input devices 170 and CPU 110, respectively to the beverage classification system 111, including direct cable connection, connection over wide area network, local network or storage area network, connection over an intranet, connection over the Internet, or connection over any other distributed processing network or system. In general, each of the links 112 and 132 can be any known or later developed connection system or structure usable to connect the one or more consumer input devices 170 and CPU 110 to the beverage classification system 111.

The input/output interface 133 inputs consumer input data from the CPU 110 and/or the one or more consumer input devices 170 and outputs data to a display such as shown by the graphical user interface in FIGS. 1-4. The input/output interface 133 also outputs the beverage classification data to one or more of the controller(s) 138, the memory 134, and the media database 134.

The memory 134 includes one or more of a beverage classification data portion 171 and a consumer input portion 172. The classification data portion 171 stores the beverage classification data into which the consumer input portion 172 will be embedded to form results information, as later discussed herein. The memory 134 can also store one or more computer readable control routines used by the controller 138 to operate the beverage classification system 111.

The memory 134 can be implemented using any appropriate combination of alterable, volatile or non-volatile memory or non-alterable, or fixed, memory. The alterable memory, whether volatile or non-volatile, can be implemented using any one or more of static or dynamic RAM, floppy disk and disk drive, writable or re-writable optical disk and disk drive, hard drive, flash memory or the like. Similarly, the non-alterable or fixed memory can be implemented using any one or more of ROM, PROM, EPROM, EEPROM, an optical ROM disk, such as CD-ROM or DVD-ROM disk, and disk drive or the like.

The controller 138 can be implemented as single special purpose integrated circuit (e.g., ASIC) each having main or central processor section for overall, system-level control, and separate sections dedicated to performing various different specific computations, functions and other processes under the control of the central processor section. The controller 138 can also be implemented as single microprocessor circuit or plurality of separate dedicated or programmable integrated or other electronic circuits or devices, e.g., hardwired electronic or logic circuits such as discrete element circuits or programmable logic devices. The controller 138 also preferably includes other circuitry or components, such as memory devices, relays, mechanical linkages, communications devices, etc., to affect desired control and/or input/output functions.

The media database 149 can be implemented using any hardware or software means capable of producing collection of data structured and organized in disciplined fashion so that access to the information of interest is possible. The database structure can be stored in any now known or later developed way of structure, such as comma delineated.

The media database 149 can contain preprogrammed sets of retail store, company or microbrewery inventory information for use by the beverage classification data portion 171 to make suggestions of similar beverages as discussed above with respect to FIG. 3. For example, the media database may contain city location, histogram references and website hyperlinks to provide information to a consumer when comparing histogram information related to beverage information stored in the beverage classification data portion 171.

In operation, and upon initiation of the beverage classification program 111 contained on or connected to CPU 110, the beverage classification data portion 171, through the input/output interface 133 and over the link 112, retrieves the consumer input data portion 172 from the beverage classification program 111 that represents the consumer input data from consumer input device 170. This process begins the initialization process of the beverage classification system 111. The initialization process performs the association and storage of the beverage classification data portion 171 with the information input by a consumer, shown herein as consumer input data portion 172.

The controller 138 then translates the incoming consumer input data portion 172 into a desired format to create an association between the consumer input data portion 172 and the beverage classification data portion 171. The desired formats include storing the consumer input data portion as beverage classification data and using linking information from the media data base 149 to the beverage classification data portion. The translation process can be implemented using any system capable of creating maps, hyperlinks and making queries into the retail store, company or microbrewery inventory information.

Upon completion of the translation process, the input/output interface 133, under the control of the controller 138, associates hyperlink, metadata pointers, etc. to the retail store, company or microbrewery inventory information. The associated hyperlink, pointer, etc. is stored in the beverage classification data portion 171 of the memory 134. The beverage classification data portion 171 including the associated hyperlink, pointer, etc. is displayed to the user on a display using conventional methods.

Once the initialization process of the beverage classification system 111 is completed, the system of this invention enters a normal operation mode. During the normal operation, when the beverage classification system 111 receives a search request from the consumer input device 170, the beverage classification system 111 searches the beverage classification data portion 171 to identify retail store, company or microbrewery inventory information to return suggested beverages that are similar in characteristics to the consumer search.

During the normal mode of operation, the search request may be entered by a consumer via consumer input devices 170. The user interface may be, for example, telephone keypad, keyboard, pointing device, speech recognition system, and the like. The search request includes information regarding the target content for which the search is to be conducted and may also include other search criteria such as keywords, topics, image search criteria, and the like.

The normal mode of operation consists of two methods of accessing data. The first method of accessing data allows user to simply input an initialization command such as double click, or carriage return on the associated stored hyperlink to access the appropriate retail store, company or microbrewery inventory. In this mode, using the user consumer input device 170, the consumer can input the command. The input/output interface 133 recognizes the form of the input and sends command to the controller 138 to access the appropriate information in the beverage classification data portion 171 of memory 134 to determine the location of the associated media clip based on the stored hyperlink. The controller 138 then retrieves the appropriate information for display.

In second method of accessing data, user can submit natural language query at CPU 110 using the consumer input device 170. The natural language query is sent to the input/output interface 133 that determines if the incoming data is in the form of natural language query. If the incoming information is in the form of natural language query, the controller 138 parses each word or phrase of the query and determines if there is appropriate beverage classification data stored in the memory 134. If there exists appropriate data, the controller 138 then retrieves the appropriate information for display.

The query parser function of he controller 138 can be implemented using any natural language retrieval system, such as the system described in U.S. Pat. No. 6,393,428 to Microsoft®. However, it should be appreciated that the query system is not limited to natural language formats. Any keyword type searching can be implemented without departing from the scope of this invention.

FIG. 7 represents an exemplary method for the beverage classification system according to this invention. As shown in FIG. 7, operation of the method begins at step S100, and continues to step S200.

In step S200, the beverage classification system receives input from a consumer requesting a preferred selection. The preferred selection may be a selection based on a histogram retrieved from the memory or it may be based on a series of inputs from a consumer as to their desired beverage characteristics. The information may be based on specific quantitative data values and/or quantitative data value ranges of information. Likewise, the information is not merely limited to information input by the user, but may include predefined information and/or information, a beverage providers available information and/or the information may be scraped from other servers and databases on the Internet and/or in other remote, yet accessible locations that relates to the beverage classification system in accordance with this invention. The routine proceeds to step S300.

In step S300, the beverage classification system will then parse the information received in steps S200 using a controller to decipher the information input by the consumer and retrieve beverage classification data based on the information. Deciphering the information may include running comparisons amongst various beverage profiles and their associated characteristics, and a ranking routine which will identify the closest matched beverages which may suitably conform closest to the properties received and analyzed. The process continues to step S400.

At step S400, a controller then displays the update information on a display with a variety of different types of information related to the beverage and its characteristics. The control routine then proceeds to step S500.

In step S500, based on the retrieved information, the beverage classification system will provide suggested or alternate beverages to the customer. The suggestions are based on the compilation of information received in step S200, the updated statistical data in step S300, and the various other bits of information collected and compared in accordance with this invention. The control routine then proceeds to step 600.

At step S600, the beverage classification system will then provide locations and/or direction to the locations having the similar beverages. It is to be noted that various types of information may be provided in accordance with this invention, such as for example, related events, and the like that may relate to the beverage classification system of this invention. The process proceeds to step S600 and then ends.

It should be appreciated that a user of the beverage classification system may create user profiles where that are continuously updated with information regarding their interaction with the beverage classification system, such as store favorite beverage selections or results of a previously performed search. Updates of the beverage classification system or the Web based information may be made based on a user's continuously updated profile, and to alert the user when such updates occur and to provide summary information regarding the updates.

The user profile used in the system described herein can be used to identify, access, retrieve and store beverage classification information and events taking place in the local community or on the Web based on a user's profile and input, either automatically or in response to a user's specific command. For example, the beverage classification system may scan the Internet for net-casted beverage classification programming and other information and events related to beverages and beverage manufacturers contained in a local database and to display.

The illustrations and examples provided herein are for explanatory purposes and are not intended to limit the scope of the appended claims. It will be recognized by those skilled in the art that changes or modifications may be made to the above described embodiment without departing from the broad inventive concepts of the invention. It is understood therefore that the invention is not limited to the particular embodiment which is described, but is intended to cover all modifications and changes within the scope and spirit of the invention.

What has been described above includes examples of the claimed subject matter. It is, of course, not possible to describe every conceivable combination of components or methodologies for purposes of describing the claimed subject matter, but one of ordinary skill in the art can recognize that many further combinations and permutations of such matter are possible.

Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed:

1. A method for classification of beverages comprising:
receiving input from an outside source information containing beverage classification data;
updating the beverage classification data with information input by a consumer; and
providing for display, on a graphical user interface, the updated beverage classification data and providing for display, related beverage classification information based on the updated beverage classification data.

2. The method of claim 1 further comprising, providing for display location information corresponding to the beverage classification data indicative of where to find similar and/or alternate beverages as related to the beverage classification data.

3. The method of claim 1, wherein the beverage classification data is comprised of at least one numerical representation of a characteristic of a beverage.

4. The method of claim 3, wherein the numerical representation is a range of values indicative of various quantitative measurements of the characteristics of the beverage.

5. The method of claim 2, wherein the location information is at least one of a hyperlink, map information or hypermedia information.

6. The method of claim 1, wherein a consumer may create a user profile wherein the beverage classification information displayed to the consumer is unique to the user profile.

7. A system for the classification of beverages comprising:
a transmission network that provides communication between a consumer input system and a central processing unit, wherein the central processing unit comprises a beverage classification program, wherein the beverage classification program includes an input/output interface for receiving input from an outside source information containing beverage classification data.

8. The system of claim 7, wherein the beverage classification data is updated with information input from by a consumer through the input/output interface.

9. The system of claim 7, wherein the beverage classification data is comprised of at least one numerical representation of a characteristic of a beverage.

10. The system of claim 8, comprising a media database containing location information corresponding to the beverage classification data, wherein the location information is information containing at least one of retail store information, store inventory information and media data for display.

11. The system of claim 9, wherein the numerical representation is a range of values indicative of various quantitative measurements of the characteristics of the beverage.

12. The system of claim 8, wherein the location information is at least one of a hyperlink, map information or hypermedia information.

13. The system of claim 7, comprising an updatable memory containing user profiles having beverage classification information.

14. A beverage classification system, comprising:
a graphical user interface that displays beverage classification data comprising:
a plurality of beverage characteristics, each scaled to define a preferred reference value within a range of possible values that describes the ingredients of the beverage;
means for adding and deleting additional beverage characteristics; and
a controller that:
dynamically receives various inputs from an outside source information containing the beverage classification data and processes the information;
updates the beverage classification data with information recently input; and
displays on the graphical user interface the updated beverage classification data, and provides for on the display, related beverage classification information based on the updated beverage classification data.

15. The beverage classification system of claim 14, wherein the preferred reference value is a range.
